(19) United States
(12) Patent Application Publication
(10) Pub. No.: US 2014/0156355 A1
(43) Pub. Date: Jun. 5, 2014

(54) BULK UPDATE IN AN ENTERPRISE MANAGEMENT SYSTEM

(71) Applicant: PRIYANKA PORWAL, Bangalore (IN)

(72) Inventor: PRIYANKA PORWAL, Bangalore (IN)

(21) Appl. No.: 13/705,440

(22) Filed: Dec. 5, 2012

(51) Int. Cl. G06Q 10/06

(52) U.S. Cl. CPC G06Q 10/0637
USPC 705/7.36

(57) ABSTRACT

Various embodiments of systems and methods for performing a bulk update to to-be-updated business object instances are described herein. Initially a request is received to retrieve information related to business object instances included in a business object. The business object instances may include to-be-updated business object instances. The information related to the business object instances may be forwarded to a client system. Based on the forwarded information, a bulk update may be received for the to-be-updated business object instances at an A2X service, in the enterprise management system. The A2X service may then update the to-be-updated business object instances with the bulk update.

### FIELD

Embodiments generally relate to computer systems, and more particularly to methods and systems for performing bulk update in an enterprise management system.

### BACKGROUND

Enterprise management system, such as SAP® Business ByDesign™ system, maintains business related information for several users/organizations. Some of the business related information, in the enterprise management system, need to be updated with additional information. For example, Government's approvals needs to be updated for each company specific business related information in the enterprise management system. Therefore, a system and method is required that allows bulk update for simultaneously updating additional information to the different business related information, in the enterprise management system.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a method for performing a bulk update to a to-be-updated business object instances, according to an embodiment.

FIGS. 2A-2B is a detailed flow diagram illustrating a method to perform bulk update to a to-be-updated business object instances, according to an embodiment.

FIG. 3 is a detailed block diagram illustrating an enterprise management system, according to an embodiment.

FIG. 4 is a block diagram illustrating an exemplary web portal for accessing an enterprise management system, according to an embodiment.

FIG. 5 is a block diagram illustrating an exemplary updated write-back document updated with the bulk update received from the Government legal department, according to an embodiment.

FIG. 6 is a block diagram illustrating a web portal after updating the bulk update to the to-be-updated customer invoice business object instances in the enterprise management system, according to an embodiment.

FIG. 7 is a block diagram illustrating a computing environment in which the techniques described for bulk updating an enterprise management system can be implemented, according to an embodiment.

### DETAILED DESCRIPTION

Embodiments of techniques for bulk updating in an enterprise management system are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

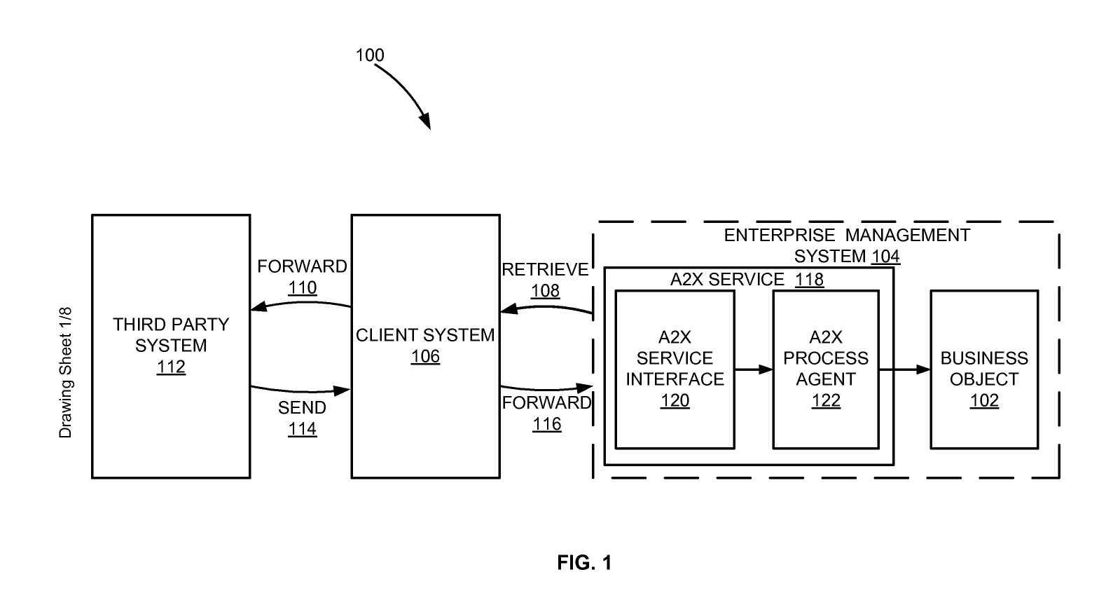

FIG. 1 is a block diagram illustrating a method 100 for performing a bulk update to a to-be-updated business object instances, according to an embodiment. The to-be-updated business object instances may be included in a business object 102. A business object 102 encapsulates a set of data and business logic into a business relevant entity. The business object 102 may include several business object instances, which are instances of the business object 102 corresponding to a particular entity. For example, a customer invoice business object may include data values, such as, customer identification number, invoice identification number, invoice type, authorization information, and authorization status, for three customers, customer ABC, customer DEF, and customer XYZ. In this case, the customer invoice business object may include three customer invoice business object instances. Each of the three customer invoice business object instances may include data values for one of the customer ABC, customer DEF, and customer XYZ.

In one embodiment, the business object instances, in the business object 102, may include to-be-updated business object instances. A to-be-updated business object instance may be a business object instance, which is to be updated with update information. The update information may be required, for example, to further process the to-be-updated business object instances. In the above example, assume that the authorization status data value for the customer ABC, customer DEF, and customer XYZ is “NOT STARTED”, “NOT STARTED”, and “APPROVED.” In this case, the customer invoice business object instances corresponding to customer ABC and customer DEF, respectively, may be a to-be-updated business object instances, which are to be updated with their corresponding authorization information. After the to-be-updated business object instances are updated with the authorization information, the authorization status value for the to-be-updated business object instances corresponding to customer ABC and customer DEF, respectively, may be changed to “APPROVED” and “APPROVED”. The business object instances corresponding to customer ABC and customer DEF, respectively, may then be forwarded to the customer ABC and customer DEF, respectively.

In one embodiment, an enterprise management system 104 may include the business object 102. An enterprise management system 104, for example an Enterprise Resource Planning (ERP) system, integrates internal and external management information, such as sales, accounting, etc., across an entire organization. For performing the bulk update on the business object instances, a client system 106 may, initially, retrieve at 108 the information related to the business object instances from the enterprise management system 104. The information related to the business object instances may include the data values of the business object instances, included in the business object 102. Next, the client system 106 may identify the to-be-updated business object instances from the business object instances, included in the business object 102. The client system may then forward at block 110 the information related to the to-be-updated business object instances to a third party system 112. In response, the third party system 112 may send at 114 the update information, related to the to-be-updated business object instances, to the client system 106. In one embodiment, the update information is a bulk update as it includes the update information for several to-be-updated business object instances.

In the above example, the user at the client system may retrieve the data values for the customer invoices corresponding to customer ABC, customer DEF, and customer XYZ, from the enterprise management system. The client system may then forward the data values of the to-be-updated customer invoice business object instances corresponding to customer ABC and customer DEF, respectively, to a third party system. The third party system may be a Government legal department, which may provide the official invoice ID (authorization information) “ABC1234” and “ABC4567” corresponding to the customer invoices of customer ABC and customer DEF, respectively. The official invoice ID “ABC1234” and “ABC4567” may be the bulk update, which is to be updated to the customer invoices of customer ABC and customer DEF, respectively. The Government legal department system may then forward the official invoice ID “ABC1234” and “ABC4567A” (bulk update) to the client system.

The client system 106 may then forward at 116 the bulk update to the enterprise management system 104. In one embodiment, an A2X service 118, at the enterprise management system 104, may receive the bulk update corresponding to the to-be-updated business object instances. An application to cross application (A2X) service 118 is a stateless synchronous inbound web-service modeled as service interface operation and implemented using a process agent framework. The A2X service 118 may be defined to perform different operations related to the business object 102. The A2X service 118 may simultaneously perform business object related operation, for example, an update operation, on any number of business object instances, included in the business object 102. An A2X service interface 120, included in the A2X service 118, may receive the bulk update from the client system 106. An A2X process agent 122 may then update the bulk update to the business object instances included in the business object 102.

In the above example, an A2X service interface, in the A2X service included in the enterprise management system, may receive the bulk update, “ABC1234” and “ABC4567” corresponding to the customer invoices of customer ABC and customer DEF, respectively. An A2X process agent may then update the to-be-updated customer invoices corresponding to the customer ABC and the customer DEF, respectively, with the bulk update, “ABC1234” and “ABC4567”, respectively.

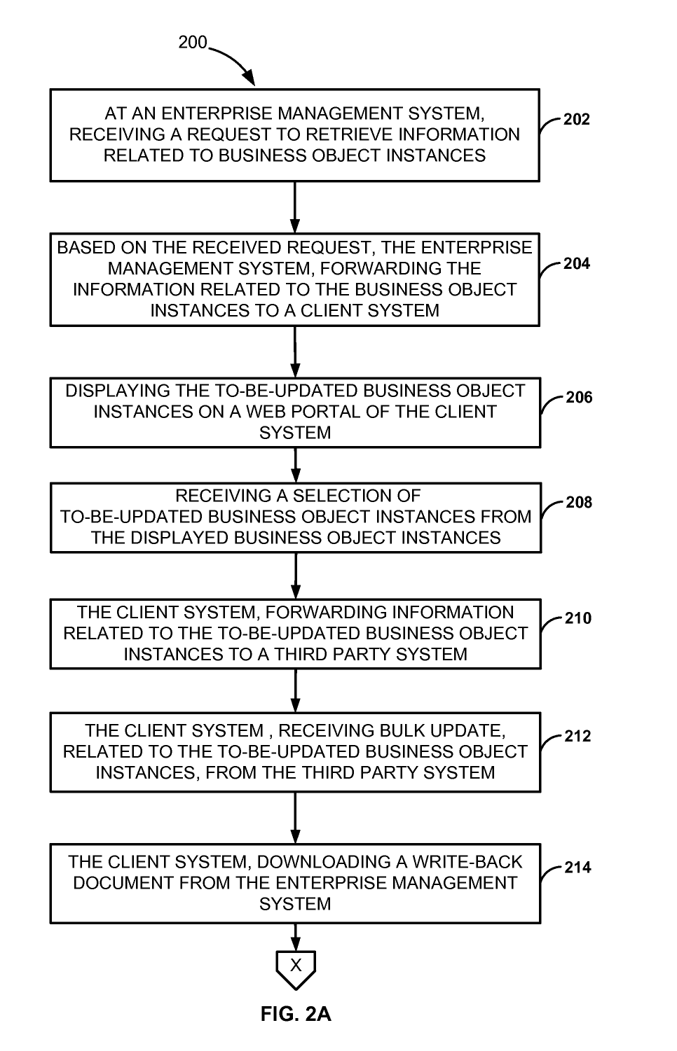

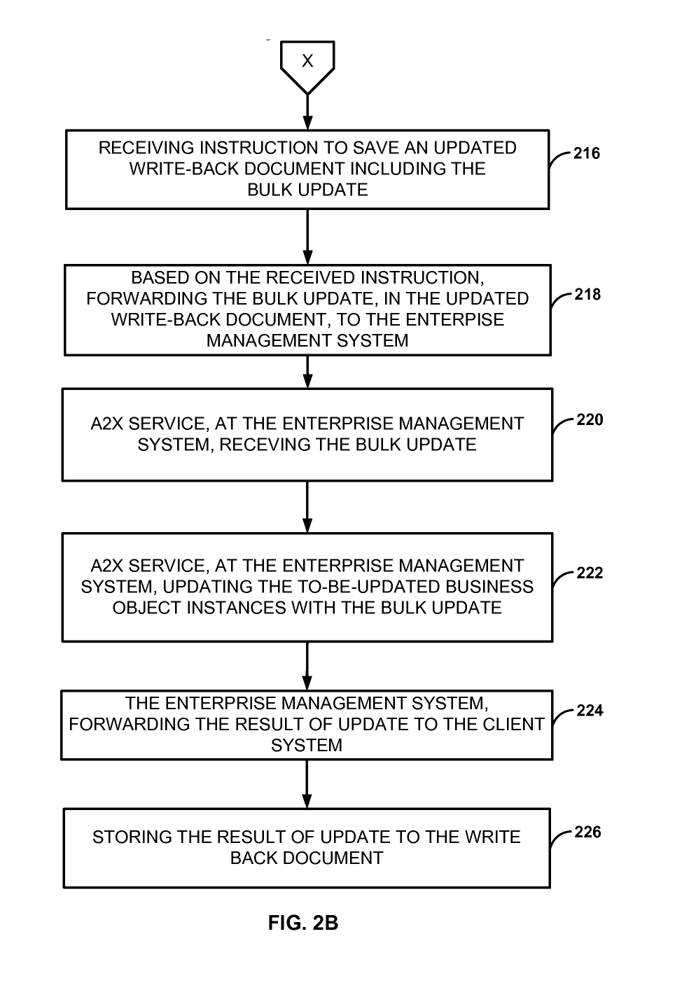

FIGS. 2A-2B is a detailed flow diagram illustrating a method 200 to perform bulk update to a to-be-updated business object instances, according to an embodiment. Initially at block 202, a request may be received, at an enterprise management system, to retrieve information related to business object instances included in the enterprise management system. In one embodiment, an enterprise management system may be a software-as-a-service (SaaS) system. SaaS is a software delivery model in which software and associated data are centrally hosted on the cloud. Cloud computing is the use of computing resources (hardware and software) that are delivered as a service over a network, for example, the internet. In one embodiment, the enterprise management system may be accessed by users using a thin client, for example, a client system, via a web portal. A web portal is a web site that brings information from diverse sources in a unified way. The web portal, at the client system, may allow the user to access the enterprise management system.

In one embodiment, the enterprise management system includes a business object, including several business object instances. The enterprise management system may receive the request from the client system to retrieve information related to business object instances, of the business object, included in the enterprise management system. The information may include data values for the business object instances included in the business object. Based on the received request, the enterprise management system may forward information related to the business object instances to the client system (block 204). For example, the enterprise management system may include a customer invoice business object, including three customer invoice business object instances. The customer invoice business object instances may include data values for several fields, such as, “approval status”, “invoice ID”, “invoice type”, “invoice date”, “Government tax number”, “authorization date” and “authorization time”. The customer invoice business object instances may correspond to three customers, “PAUL”, “JONATHAN”, and “MARY”. The data values for the customer invoice business objects corresponding to the three customers “PAUL”, “JONATHAN”, and “MARY”, respectively, may be forwarded to a client system.

Next at block 206, the forwarded information related to the business object instances may be displayed at the web portal of the client system. In one embodiment, the data values of the business object instances may be displayed at the web portal. A user at the client system may then select the to-be-updated business object instance from the displayed business object instances (block 208). The user, at the client system, may select the to-be-updated business object instances based on the data values, of the business object instances, displayed at the web portal. A to-be-updated business object instance may be a business object instance, in which the data values, for some of the fields, are to be updated. In the above example, the data values for the customer invoice business objects corresponding to the three customers “PAUL”, “JONATHAN”, and “MARY”, respectively, may be displayed at a web portal of the client system. Assume, that the “approval status” values for customers “PAUL”, “JONATHAN”, and “MARY” is “NOT STARTED”, “NOT STARTED”, and “APPROVED”, respectively. In this case, the user may select the customer invoice business object instances for “PAUL” and “JONATHAN” as the to-be-updated business object instances, which are to be updated with the data values corresponding to the “Government tax number”, “authorization date”, and “authorization time” fields.

Next at block 210, the client system may forward the information related to the to-be-updated business object instances to a third party system. A third party system may be any system capable of providing the update information related to the to-be-updated business object instances. In one embodiment, the authorization information provided by the third party system is a bulk update as it includes a set of update information corresponding to several to-be-updated business object instances. In the above example, the third party system may be a Government legal department system that may provide the bulk update related to the to-be-updated business object instances of “PAUL” and “JONATHAN”, respectively. The bulk update may include a Government tax number, for example, a Golden tax invoice number in case of the Chinese Government legal department. The bulk update may also include the date and time when the authorization is received at the Government legal system. Next at block 212, the client system may receive the bulk update, related to the to-be-updated business object instances, from the third party system. The third party system may forward the bulk update to the client system by any mode of communication, for example, an E-Mail.

Next at block 214, the client system may download a write back document, to update the bulk update received from the third party system. In one embodiment, a user request may be received, on the web portal at the client system, to download the write back document from the enterprise management system. Based on the received request, the write back document may be downloaded from the enterprise management system to the client system. A write back document may be an interactive software application, such as a spreadsheet, which allows a user to organize and analyze information. For example, the write-back document may be a Microsoft® Excel® document. In the above example, a Microsoft® Excel® document may be downloaded from the enterprise management system. The Microsoft® Excel® document may include columns for updating the bulk update, which may include data values of “Government tax number”, “authorization date”, and ‘authorization time” fields, for the to-be-updated customer invoices of “PAUL” and “JONATHAN”, respectively, received from the Government legal system.

The user at the client system may manually input the bulk update received from the third party system to the write back document. In the above example, consider that the update information, for the to-be-updated customer invoice business object instance of “PAUL”, includes the data values “ABC-01”, “AXXXXA”, “NOVEMBER 10, 2012” and “12:00:00 PM” for the parameters “invoice ID”, “Government tax number”, “authorization date”, and ‘authorization time”, respectively. Similarly the update information, for the -be-updated customer invoice business object instance of “JONATHAN”, includes the data values “ABC-02”, “BXXXXB”, “NOVEMBER 10, 2012” and “12:30:00 PM.” The user may update the bulk update, which includes the update information, “PAUL”, “AXXXXA”, “NOVEMBER 10, 2012” and “12:00:00 PM” and “JONATHAN”, “BXXXXB”, “NOVEMBER 10, 2012” and “12:30:00 PM”, corresponding to the to-be-updated customer invoices of customer “PAUL” and “JONATHAN”, respectively, to the write back document. In one embodiment, the user may update the authorization information to a write back document existing in the client system.

In one embodiment, the updated write back document may be transformed to an extensible markup language (XML) message. The XML message may include the bulk update included in the updated write back document. The XML message may be in a format which can be processed by the A2X service included in the enterprise management system. In one embodiment, an XML map may be used to transform the updated write back document to the XML message. An XML map may define transforms, which are actions to be performed on the data of the input element (updated write-back document). The result of the transform is placed in the output element, which is the XML message including the bulk update. In case the updated write-back document is a Microsoft® Excel® document, then the cells of the Microsoft® Excel® document, including the bulk update, may be pre-programmed to transfer the bulk update to an XML message. In the above example, the write back document may be transformed to the following XML message that includes the bulk update for the to-be-updated customer invoices of customer “PAUL” and “JONATHAN”, respectively.

```
<ns1:CN_CustomerInvoiceLegalAuthorisationBundleMaintain-
Request_sync
xmlns:ns1=“http://abc.com/xi/ABCGlobal/Global”>
    <BasicMessageHeader />
    <LastUpdatedDateTime
    xmlns:ns1=“http://abc.com/xi/ABCGlobal/Global”>2012-11-
    13T12:00:00.000</LastUpdatedDateTime>
    <StatusMessageText xmlns:ns1=“http://abc.com/xi/ABCGlobal/
    Global”>Some records have not been saved to ENTERPRISE
    MANAGEMENT SYSTEM
    </StatusMessageText>
    <CN_CustomerInvoiceLegalAuthorisation actionCode=“XX”
    xmlns:ns1=“http://abc.com/xi/A1SGlobalization/Global”>
        <ID>ABC-01</ID>
        <InvoiceLegallyAuthorisedDateTime>2012-11-
        10T12:00:00</InvoiceLegallyAuthorisedDateTime>
        <InvoiceLegallyAuthorisedID>AXXXXA</
        InvoiceLegallyAuthorisedID>
    </CN_CustomerInvoiceLegalAuthorisation>
    <CN_CustomerInvoiceLegalAuthorisation actionCode=“XX”
    xmlns:ns1=“http://abc.com/xi/ABCGlobal/Global”>
        <ID>ABC-02</ID>
        <InvoiceLegallyAuthorisedDateTime>2012-11-
        10T12:30:00</InvoiceLegallyAuthorisedDateTime>
        <InvoiceLegallyAuthorisedID>BXXXXB</
        InvoiceLegallyAuthorisedID>
    </CN_CustomerInvoiceLegalAuthorisation>
```

Next at block 216, the client system may receive a request to save the updated write-back document, including the bulk update, to the enterprise management system. The request may be received from a user on the web portal at the client system. Based on the received save instruction, the client system may forward the bulk update, related to the to-be-updated business object instances to the enterprise management system (block 218). In one embodiment, the bulk update may be country specific legal authorization information for several to-be-updated customer invoice business object instances. The client system forwards the XML message, which includes the bulk update, to the enterprise management system. In the above example, the XML message that includes the bulk update for “PAUL” and “JONATHAN” may be forwarded to the enterprise management system.

An A2X service at the enterprise management system may receive the bulk update forwarded by the client system (block 220). The A2X service may then update the received bulk update to the to-be-updated business object instances of the business object included in the enterprise management system (block 222). In one embodiment, the A2X service may update the country specific legal authorization information to the to-be-updated customer invoice business object instances. A2X service is a stateless synchronous inbound web-service modeled as a service interface operation and implemented by a process agent. The A2X service may allow direct interaction between a user, at a client system, and the enterprise management system. The A2X service may be defined at the level of business objects included in the enterprise management system. In one embodiment, the A2X service may include an A2X service interface, which is a collection of operations to be performed on the business object stored in the enterprise management system. The operations in the A2X service interface may include, for example, a create operation to create instances of the business object in the enterprise management system, a delete operation to delete instances of the business object in the enterprise management system, or an update operation to update information in any of the business object instances in the enterprise management system. The A2X service may also include an A2X process agent for implementing the business object related operation defined by the A2X service interface.

As the A2X service is defined at the business object level, the A2X service may allow communication, between a user/client system on the enterprise management system and the enterprise management system, independent of the type of user/client system. The A2X service may also allow simultaneous execution of business object related operation, for example, an update information, for any number of business object instances of the business object included in the enterprise management system. The write back document, including the bulk update, is received by the A2X service interface included in the A2X service. The A2X service interface may then forward the XML message, including the bulk update, to the A2X process agent that may update the to-be-updated business object instances with the bulk update included in the XML message. In the above example, the bulk update, “PAUL”, “AXXXXA”, “NOVEMBER 10, 2012” and “12:00:00 PM” and “JONATHAN”, “BXXXXB”, “NOVEMBER 10, 2012” and “12:30:00 PM”, included in the XML message, may be updated to the customer invoice of “JONATHAN” and “PAUL”, respectively.

In one embodiment, the enterprise management system may forward the result of updating the business object instances to the client system (block 224). The result of update may include a confirmation message indicating whether the bulk update to the to-be-updated business object instances is successful or unsuccessful. Finally at block 226, the result of updating may be stored in the write back document at the client system.

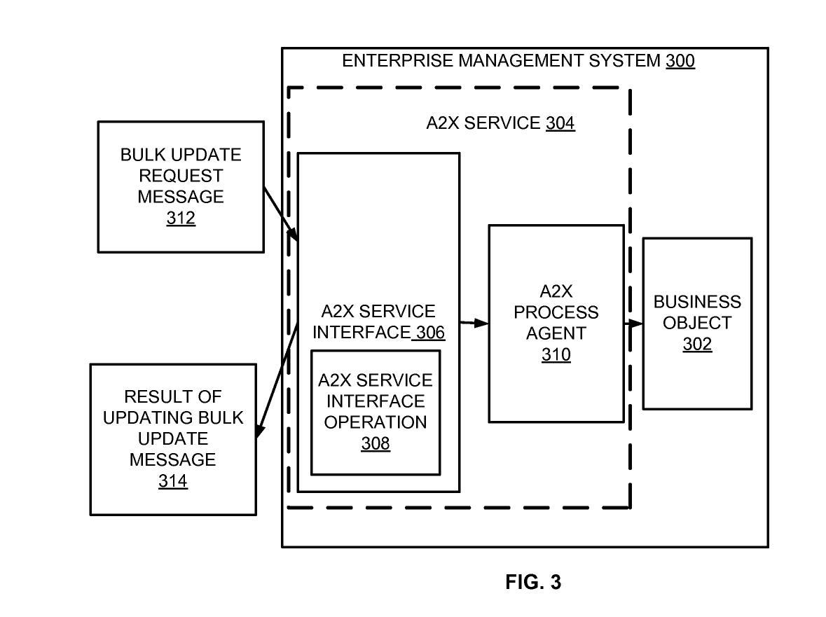

FIG. 3 is a detailed block diagram illustrating an enterprise management system 300, according to an embodiment. The enterprise management system includes a business object 302, which may include business object instances. In one embodiment, the business object 302 may be a customer invoice business object. The enterprise management system 300 may also include an A2X service 304, which may allow a direct communication between the business object 302 and an external user. The external user may communicate with the business object 302 to perform different business object related operations. In one embodiment, the A2X service 304 may include an A2X service interface 306, which defines the possible business object related operations, for example, updating business object instances, offered by the A2X service. The business object related operations are grouped into the A2X service interface 306 independent of any possible user/client system. The A2X service interface 306 may receive instructions for performing any of the business object related operations from the external user. In one embodiment, the A2X service 304 includes an A2X service interface operation 308, which includes the business object related operations defined by the A2X service 304. The business object related operations, included in the A2X service interface operation 308 may be implemented by an A2X process agent 310 included in the A2X service 304. For example, if the A2X service interface operation 308 includes an update operation, then the A2X process agent 310 implements the update operation on the business object instances included in the business object 302.

In one embodiment, when a user at a client system initiates a save operation to save an updated write-back document, including bulk update, then a bulk update request message 312 is forwarded to the A2X service interface 306. The bulk update request message 312 may be in XML format and may include the bulk message to be updated to the to-be-updated business object instances. The A2X service interface 306 may transfer the received bulk update request message 312 to the A2X process agent 310, which may then update the to-be-updated business object instances, in the business object 302, with the bulk message. Finally, a message 314 including the result of the updating the bulk update to the to-be-updated business object instances may be sent back to the client system.

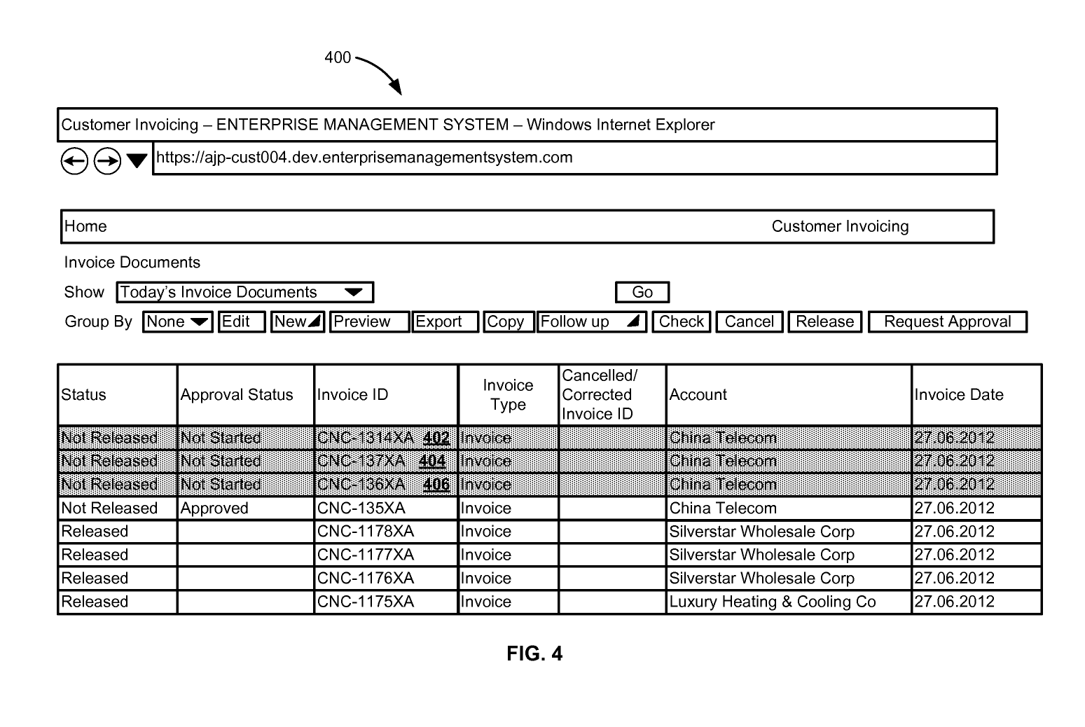

FIG. 4 is a block diagram illustrating an exemplary web portal 400 for accessing an enterprise management system, according to an embodiment. The web portal 400 may be displayed to a user at a client system. The web portal 400 displays the data values, for the “status”, approval status”, “invoice ID”, “Invoice Type”, and “Account” fields, of customer invoice business object instances included in the enterprise management system. A user at the client system may select three customer invoices having the invoice ID “CNC-1314XA” 402, “CNC-137XA” 404, and “CNC-136XA” 406, respectively. The three customer invoices, having the invoice ID “CNC-1314XA” 402, “CNC-137XA” 404, and “CNC-136XA” 406, respectively, may be selected, as the approval status of these three customer invoices is “NOT STARTED”. These three customer invoices are to be approved by the Government legal department. The client system may forward the data values, of the three customer invoices to a Government legal department.

The Government legal department may provide an official invoice ID number for each of these customer invoice business object instances having the invoice ID “CNC-1314XA” 402, “CNC-137XA” 404, and “CNC-136XA” 406, respectively. The data values, of the “status”, approval status”, “invoice ID”, “Invoice Type”, and “account” fields, for the three selected customer invoice business object instances may be forwarded to the Government legal department. The Government legal department may then send an Official Invoice ID for the select customer invoice business object instances having the invoice ID “CNC-1314XA” 402, “CNC-137XA” 404, and “CNC-136XA” 406, respectively.

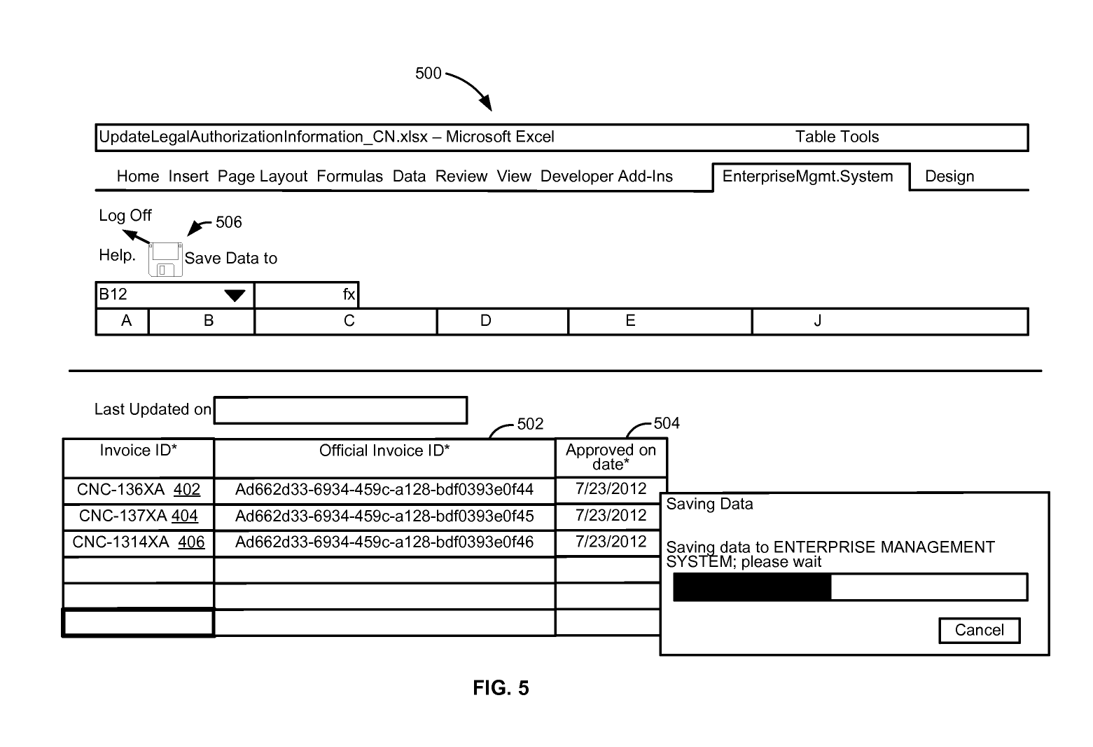

FIG. 5 is a block diagram illustrating an exemplary updated write-back document 500 updated with the bulk update received from the Government legal department, according to an embodiment. After receiving the official invoice ID from the Government legal department, a user may update the invoice ID, official invoice ID, and approved on date, for the to-be-updated business object instances, to the write-back document. The official invoice ID 502 and the “approved on date” 504 values for the three customer invoices may be the bulk update for the three to-be-updated customer invoice business object instances. A user may then initiate a save operation 506 to save the updated write back document to the enterprise management system. Based on the initiated save operation 506, the bulk update may be updated to the corresponding to-be-updated business object instances in the enterprise management system.

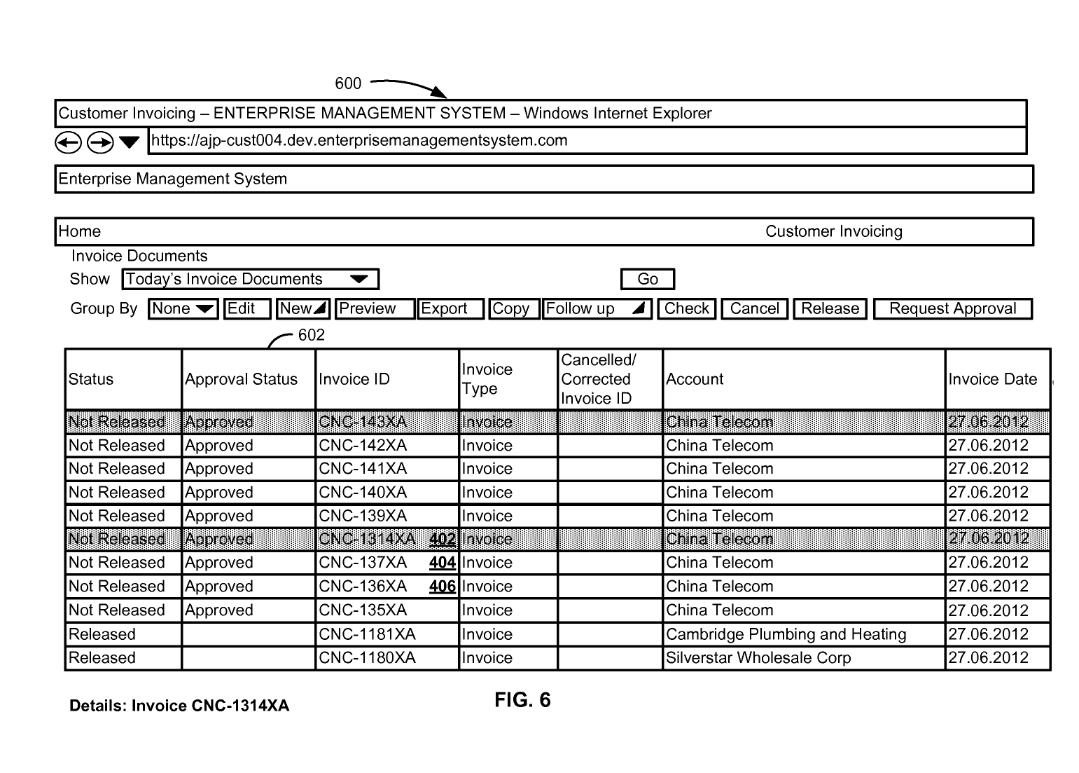

FIG. 6 is a block diagram illustrating a web portal 600 after updating the bulk update to the to-be-updated customer invoice business object instances in the enterprise management system, according to an embodiment. As shown, the approval status 602 for the three to-be-updated customer invoices having the invoice ID “CNC-1314XA” 402, “CNC-137XA” 404, and “CNC-136XA” 406, respectively, is shown as “APPROVED”, after the bulk update has been updated to the corresponding to-be-updated business object instances in the enterprise management system.

Some embodiments may include the above-described methods being written as one or more software components. These components, and the functionality associated with each, may be used by a client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls or web services being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

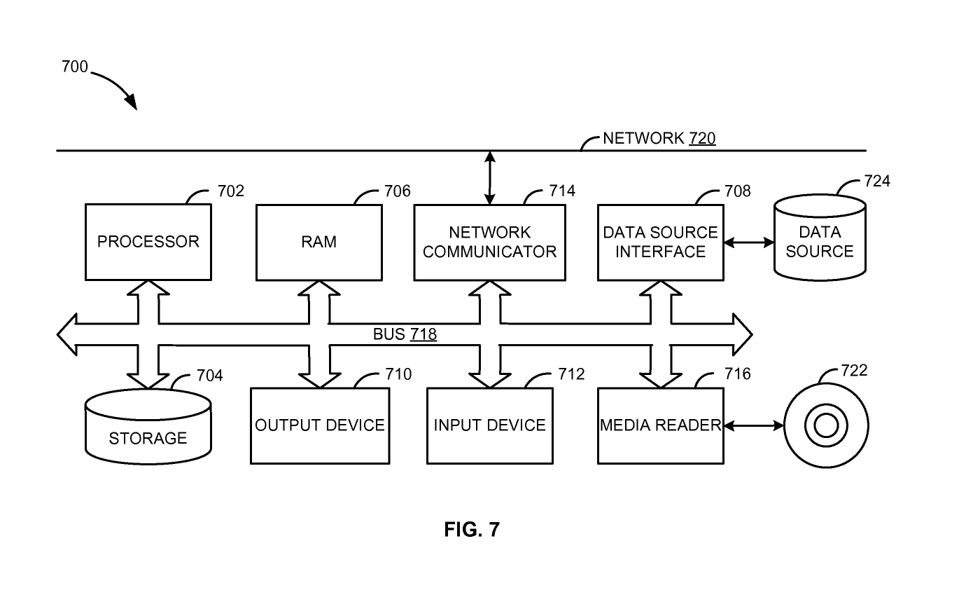

FIG. 7 is a block diagram of an exemplary computer system 700. The computer system 700 includes a processor 702 that executes software instructions or code stored on a computer readable storage medium 722 to perform the above-illustrated methods. The computer system 700 includes a media reader 716 to read the instructions from the computer readable storage medium 722 and store the instructions in storage 704 or in random access memory (RAM) 706. The storage 704 provides a large space for keeping static data where at least some instructions could be stored for later execution. The stored instructions may be further compiled to generate other representations of the instructions and dynamically stored in the RAM 706. The processor 702 reads instructions from the RAM 706 and performs actions as instructed. According to one embodiment, the computer system 700 further includes an output device 710 (e.g., a display) to provide at least some of the results of the execution as output including, but not limited to, visual information to users and an input device 712 to provide a user or another device with means for entering data and/or otherwise interact with the computer system 700. Each of these output devices 710 and input devices 712 could be joined by one or more additional peripherals to further expand the capabilities of the computer system 700. A network communicator 714 may be provided to connect the computer system 700 to a network 720 and in turn to other devices connected to the network 720 including other clients, servers, data stores, and interfaces, for instance. The modules of the computer system 700 are interconnected via a bus 718. Computer system 700 includes a data source interface 708 to access data source 724. The data source 724 can be accessed via one or more abstraction layers implemented in hardware or software. For example, the data source 724 may be accessed by network 720. In some embodiments the data source 724 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

1. A computer system for performing a bulk update to a plurality of to-be-updated business object instances, the method comprising:
a processor; and
a memory coupled to the processor to store program code, the program code comprising:
an enterprise management system in communication with a client system, the enterprise management system including:
a business object including the plurality of to-be-updated business object instances; and
an application-to-cross application (A2X) service operable to receive the bulk update, related to the plurality of business object instances, from the client system, and to update the plurality of to-be-updated business object instances with the received bulk update.

2. The computer system according to claim 1, wherein the A2X service includes:
an A2X service interface operable to receive the bulk update from the client system; and
an A2X inbound process agent operable to update the to-be-updated business object instances with the bulk update.

3. The computer system according to claim 2, wherein the A2X service interface includes:
one or more A2X service interface operations defining business object related operations provided by the A2X service, the business object related operations including an update operation to update the plurality of to-be-updated business object instances.

4. The computer system according to claim 1, wherein the program code further comprises:
the client system operable to download a write-back document from the enterprise management system and to forward an updated write-back document, including the bulk update, to the enterprise management system.

5. The computer system according to claim 1, wherein the client system includes a web portal operable to communicate with the enterprise management system.

6. The computer system according to claim 1, wherein the program code further comprises:
a third party system in communication with the client system, the third party system operable to forward the bulk update to the client system.

7. A computer implemented method for performing a bulk update to a plurality of to-be-updated business object instances, the method comprising:
receiving, at an enterprise management system, a request to retrieve information related to a plurality of business object instances included in a business object, stored in a memory of the computer, the plurality of business object instances including a plurality of to-be-updated business object instances;
forwarding, by a processor of the computer, the information related to the plurality of business object instances to a client system;
based on the forwarded information, an A2X service, included in the enterprise management system, receiving the bulk update, related to the plurality of to-be-updated business object instances, from the client system; and
the A2X service, updating the to-be-updated business object instances, included in the business object, with the bulk update.

8. The computer implemented method according to claim 7, further comprising:
executing a web portal, at the client system, to establish a communication between the client system and the enterprise management system.

9. The computer implemented method according to claim 8, further comprising:
displaying at the web portal of the client system, the information related to the plurality of business object instances; and
based on the displayed information, receiving, at the web portal, a selection of the to-be-updated business object instances from the plurality of business object instances.

10. The computer implemented method according to claim 8, further comprising:
based on a request received at the web portal of the client system, downloading a write-back document, from the enterprise management system, to update the bulk update to the write-back document;
at the web portal of the client system, receiving a save instruction to store an updated write-back document, including the bulk update, to the enterprise management system; and
based on the received save instruction, forwarding the bulk update, included in the updated write-back document, to the enterprise management system.

11. The computer implemented method according to claim 10, further comprising:
converting the write back document to an extensible markup language (XML) file, the XML message including the bulk update; and
forwarding the XML message, including the bulk update, to the enterprise management system.

12. The computer implemented method according to claim 7, further comprising:
the enterprise management system, forwarding a result of the bulk update operation to the client system.

13. The computer implemented method according to claim 12, further comprising:
storing the result of the bulk update operation to a write back document downloaded at the client system.

14. The computer implemented method according to claim 7, further comprising:
the client system, forwarding the information related to the to-be-updated business object instances to a third party system; and
the client system, receiving the bulk update, related to the to-be-updated business object instances, from the third party system.

15. An article of manufacture including a non-transitory computer readable storage medium to tangibly store instructions, which when executed by a computer, cause the computer to:
receive, at an enterprise management system, a request to retrieve information related to a plurality of business object instances included in a business object, the plurality of business object instances including a plurality of to-be-updated business object instances;
forward the information related to the plurality of business object instances to a client system;
based on the forwarded information, an A2X service, included in the enterprise management system, receive the bulk update, related to the plurality of to-be-updated business object instances, from the client system; and
the A2X service, update the to-be-updated business object instances, included in the business object, with the bulk update.

16. The article of manufacture of claim 15, further comprising instructions which when executed by the computer further causes the computer to:
execute a web portal, at the client system, to establish a communication between the client system and the enterprise management system.

17. The article of manufacture of claim 16, further comprising instructions which when executed by the computer further causes the computer to:
display, at the web portal of the client system, the information related to the plurality of business object instances; and
based on the displayed information, receive, at the web portal, a selection of the to-be-updated business object instances from the plurality of business object instances.

18. The article of manufacture of claim 16, further comprising instructions which when executed by the computer further causes the computer to:
based on a request received at the web portal of the client system, download a write-back document, from the enterprise management system, to update the bulk update to the write-back document;
at the web portal of the client system, receive a save instruction to store an updated write-back document, including the bulk update, to the enterprise management system; and
based on the received save instruction, forward the bulk update, in the updated write-back document, to the enterprise management system.

19. The article of manufacture of claim 18, further comprising instructions which when executed by the computer further causes the computer to:
convert the write back document to an extensible markup language (XML) file, the XML message including the bulk update; and
forward the XML message, including the bulk update, to the enterprise management system.

20. The article of manufacture of claim 15, further comprising instructions which when executed by the computer further causes the computer to:
the enterprise management system, forward a result of the bulk update operation to the client system.
